(19) United States
(12) Patent Application Publication
(10) Pub. No.: US 2012/0218215 A1
(43) Pub. Date: Aug. 30, 2012

(54) Methods for Detecting and Tracking Touch Objects

(76) Inventors: Andrew Kleinert, Acton (AU); Richard Pradenas, Acton (AU); Michael Bantel, Acton (AU); Dax Kukulj, Acton (AU)

(21) Appl. No.: 13/502,324

(22) PCT Filed: Oct. 15, 2010
(86) PCT No.: PCT/AU2010/001374

§ 371 Date: May 10, 2012

Related U.S. Application Data
(60) Provisional application No. 61/286,525, filed on Dec. 15, 2009.

(30) Foreign Application Priority Data
Oct. 16, 2009 (AU) 2009905037

(51) Int. Cl. G06F 3/041

(52) U.S. Cl. 345/173

(57) ABSTRACT

In a touch sensitive user interface environment having a series of possible touch points on an activation surface, with the monitoring of the touch points being achieved by sensing activation values at a plurality of positions around the periphery of the activation surface, a method of determining where at least one touch point has been activated on the surface, the method including the steps of: (a) determining at least one intensity variation in the activation values; and (b) utilizing a gradient measure of the sides of the at least one intensity variation to determine the location of at least one touch point on the activation surface.

### RELATED APPLICATIONS

The present application claims priority from Australian provisional patent application No 2009905037 filed on 16 Oct. 2009 and U.S. provisional patent application No. 61/286,525 filed on 15 Dec. 2009. The contents of both provisional applications are incorporated herein by reference.

### FIELD OF THE INVENTION

The present invention relates to methods for detecting and tracking objects interacting with a touch screen. The invention has been developed primarily to enhance the multi-touch capability of infrared-style touch screens and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

Input devices based on touch sensing (referred to herein as touch screens irrespective of whether the input area corresponds with a display screen) have long been used in electronic devices such as computers, personal digital assistants (PDAs), handheld games and point of sale kiosks, and are now appearing in other portable consumer electronics devices such as mobile phones. Generally, touch-enabled devices allow a user to interact with the device, for example by touching one or more graphical elements such as icons or keys of a virtual keyboard presented on a display, or by writing or drawing on a display or pad.

Several touch-sensing technologies are known, including resistive, surface capacitive, projected capacitive, surface acoustic wave, optical and infrared, all of which have advantages and disadvantages in areas such as cost, reliability, ease of viewing in bright light, ability to sense different types of touch object, e.g. finger, gloved finger or stylus, and single or multi-touch capability.

The various touch-sensing technologies differ widely in their multi-touch capability, i.e. their performance when faced with two or more simultaneous touch events. Some early touch-sensing technologies such as resistive and surface capacitive are completely unsuited to detecting multiple touch events, reporting two simultaneous touch events as a ‘phantom touch’ halfway between the two actual points. Certain other touch-sensing technologies have good multi-touch capability but are disadvantageous in other respects. One example is a projected capacitive touch screen adapted to interrogate every node (an ‘all-points-addressable’ device), discussed in US Patent Application Publication No 2006/0097991 A1 that, like projected capacitive touch screens in general, can only sense certain touch objects (e.g. gloved fingers and non-conductive styluses are unsuitable) and uses high refractive index transparent conductive films that are well known to reduce display viewability, particularly in bright sunlight. In another example video camera-based systems, discussed in US Patent Application Publication Nos 2006/0284874 A1 and 2008/0029691 A1, are extremely bulky and unsuitable for hand-held devices. Another touch technology with good multi-touch capability is ‘in-cell’ touch, where an array of sensors are integrated with the pixels of a display (such as an LCD or OLED display). These sensors are usually photo-detectors (disclosed in U.S. Pat. No. 7,166,966 and US Patent Application Publication No 2006/0033016 A1 for example), but variations involving micro-switches (US 2006/0001651 A1) and variable capacitors (US 2008/0055267 A1), among others, are also known. In-cell approaches cannot be retro-fitted and generally add complexity to the manufacture and control of the displays in which the sensors are integrated. Furthermore those that rely on ambient light shadowing cannot function in low light conditions.

Touch screens that rely on the shadowing (i.e. partial or complete blocking) of energy paths to detect and locate a touch object occupy a middle ground in that they can detect the presence of multiple touch events but are often unable to determine their locations unambiguously, a situation commonly described as ‘double touch ambiguity’. To explain, FIG. 1 illustrates a conventional ‘infrared’ style of touch screen 2, described for example in U.S. Pat. Nos. 3,478,220 and 3,764,813, including arrays of discrete light sources 4 (e.g. LEDs) along two adjacent sides of a rectangular input area 6 emitting two sets of parallel beams of light 8 towards opposing arrays of photo-detectors 10 along the other two sides of the input area. The sensing light is usually in the infrared region of the spectrum, but could alternatively be visible or ultraviolet. The simultaneous presence of two touch objects A and B can be detected by the blockage, partial or complete, of two beams or groups of beams in each axis, however it will be appreciated that, without extra information, their actual locations 12, 12′ cannot be distinguished from two ‘phantom’ points 14, 14′ located at the other two diagonally opposite corners of the nominal rectangle 16. Surface acoustic wave (SAW) touch input devices operate using similar principles except that the sensing energy paths are in the form of acoustic waves rather than light beams and, as discussed in U.S. Pat. No. 6,723,929, suffer from the same double touch ambiguity. Projected capacitive touch screens that only interrogate columns and rows, resulting in faster scan rates than for all-points-addressable operation, also fall into this category (see US Patent Application Publication No US 2008/0150906 A1).

Even if the correct points can be distinguished from the phantom points in a double touch event, further complications can arise if the device controller has to track moving touch objects. For example if two moving touch objects A and B (FIG. 2A) on an ‘infrared’ touch screen 2 move into an ‘eclipse’ state (as shown in FIG. 2B), the ambiguity between the actual locations 12, 12′ and the phantom points 14, 14′ recurs when the objects move out of the eclipse state. FIGS. 2C and 2D illustrate two possible motions out of the eclipse state, referred to hereinafter as a ‘crossing event’ and a ‘retreating event’ respectively, that are, without further information, indistinguishable to the device controller. This recurrence of the double touch ambiguity will be referred to hereinafter as the ‘eclipse problem’.

Conventional infrared touch screens 2 require a large number of light sources 4 and photo-detectors 10. FIG. 3 illustrates a variant infrared-style device 18 with a greatly reduced optoelectronic component count, described in U.S. Pat. No. 5,914,709, where the arrays of light sources are replaced by arrays of ‘transmit’ optical waveguides 20 integrated on an L-shaped substrate 22 that distribute light from a single light source 4 via a 1×N splitter 24 to produce a grid of light beams 8, and the arrays of photodetectors are replaced by arrays of ‘receive’ optical waveguides 26 integrated on another L-shaped substrate 22′ that collect the light beams and conduct them to a multi-element detector 28 (e.g. a line camera or a digital camera chip). Each optical waveguide terminates in an in-plane lens 30 that collimates the signal light in the plane of the input area 6, and the device may also include cylindrically curved vertical collimating lenses (VCLs) 32 to collimate the signal light in the out-of-plane direction. For simplicity FIG. 3 only shows four waveguides per side of the input area; in actual devices the in-plane lenses will be sufficiently closely spaced such that the smallest likely touch object will block a substantial portion of at least one beam in each axis.

In yet another variant infrared-style device 34 shown in FIG. 4 and disclosed in US Patent Application Publication No 2008/0278460 A1, entitled ‘A transmissive body’ and incorporated herein by reference, the ‘transmit’ waveguides 20 and associated in-plane lenses 30 of the FIG. 3 device 18 are replaced by a transmissive body 36 including a light guide plate 38 and two collimation/redirection elements 40 that include parabolic reflectors 42. Infrared light 44 from a pair of optical sources 4 is launched into the light guide plate, then collimated and re-directed by the collimation/redirection elements to produce two sheets of light 46 that propagate in front of the light guide plate towards the receive waveguides 26, so that a touch event can be detected from those portions of the light sheets 46 blocked by the touch object. Clearly the light guide plate 38 needs to be transparent to the infrared light 44 emitted by the optical sources 4, and it also needs to be transparent to visible light if there is an underlying display (not shown). Alternatively, a display may be located between the light guide plate and the light sheets, in which case the light guide plate need not be transparent to visible light. As in the FIG. 3 device, the input device 34 may also include VCLs to collimate the light sheets 46 in the out-of-plane direction, in close proximity to either the exit facets 47 of the collimation/redirection elements, or the receive-side in-plane lenses 30, or both. Alternatively, the exit facets of the collimation/redirection elements could have cylindrical curvature to provide vertical collimation. In yet other embodiments there may be no vertical collimation elements.

A common feature of the infrared touch input devices shown in FIGS. 1, 3 and 4 is that the sensing light is provided in two fields containing parallel rays of light, either as discrete beams (FIGS. 1 and 3) or as more or less uniform sheets of light (FIG. 4). The axes of the two light fields are usually perpendicular to each other and to the sides of the input area, although this is not essential (see for example U.S. Pat. No. 5,414,413). Since in each case a touch event is detected by the shadowing of light paths, it will be appreciated that all are susceptible to the ‘double touch ambiguity’ and ‘eclipse problem’ illustrated in FIGS. 1 and 2A-2D respectively. SAW and certain projected capacitive touch screens are similarly susceptible to double touch ambiguity and the eclipse problem.

The so-called ‘optical’ touch screen is somewhat different from an ‘infrared’ touch screen in that the sensing light is provided in two fan-shaped fields. As shown in plan view in FIG. 16, an ‘optical’ touch screen 86 typically comprises a pair of optical units 88 in adjacent corners of a rectangular input area 6 and a retro-reflective layer 90 along three edges of the input area. Each optical unit includes a light source emitting a fan of light 92 across the input area, and a multi-element detector (e.g. a line camera) where each detector pixel receives light retro-reflected from a certain portion of the retro-reflective layer. A touch object 94 in the input area prevents light reaching one or more pixels in each detector, and its position determined by triangulation. Referring now to FIG. 17, it will be seen that an optical touch screen 86 is also susceptible to the double touch ambiguity problem, except that the actual touch points 12, 12′ and the phantom points 14, 14′ lie at the corners of a quadrilateral rather than a rectangle. There is a need then to improve the multi-touch capability of touch screens and in particular infrared-style touch screens.

Various ‘hardware’ modifications are known in the art for enhancing the multi-touch capability of touch screens, see for example U.S. Pat. No. 6,723,929 and US Patent Application Publications Nos 2008/0150906 A1 and 2009/0237366 A1. These improvements generally involve the provision of sensing beams or nodes along a third or even a fourth axis, thereby providing additional information that allows the locations of two or three touch objects to be determined unambiguously. However hardware modifications generally require additional components, increasing the cost and complicating device assembly.

### OBJECT OF THE INVENTION

It is an object of the present invention to overcome or ameliorate at least one of the disadvantages of the prior art, or to provide a useful alternative. It is an object of the invention in its preferred form to improve the multi-touch capability of infrared-style touch screens.

### SUMMARY OF THE INVENTION

In accordance with a first aspect of the present invention, there is provided in a touch sensitive user interface environment having a series of possible touch points on an activation surface, with the monitoring of the touch points being achieved by sensing activation values at a plurality of positions around the periphery of the activation surface, a method of determining where at least one touch point has been activated on the surface, the method including the steps of: (a) determining at least one intensity variation in the activation values; and (b) utilising a gradient measure of the sides of the at least one intensity variation to determine the location of at least one touch point on the activation surface.

The number of touch points can be at least two and the location of the touch points can be determined by reading multiple intensity variations along the periphery of the activation surface and correlating the multiple points to determine likely touch points. Preferably, adjacent opposed gradient measures of at least one intensity variation are utilised to disambiguate multiple touch points.

The method further preferably can include the steps of: continuously monitoring the time evolution of the touch point intensity variations in the activation values; and utilising the timing of the intensity variations in disambiguating multiple touch points. In some embodiments, a first identified intensity variation can be utilised in determining the location of a first touch point and a second identified intensity variation can be utilised in determining the location of a second touch point In other embodiments, the activation surface preferably can include a projected series of icons thereon and the disambiguation favours touch point locations corresponding to the icon positions. The dimensions of the intensity variations are preferably utilised in determining the location of the at least one touch point.

Further, recorded shadows diffraction characteristics of an object are preferably utilised in disambiguating possible touch points. In some embodiments, the sharpness of the shadow diffraction characteristics are preferably associated with the distance of the object from the periphery of the activation area. In some embodiments, the disambiguation of possible touch points can be achieved by monitoring the time evolution profile of the intensity variations and projecting future locations of each touch point.

In accordance with a further aspect of the present invention, there is provided a method of determining the location of one or more touch points on a touch sensitive user interface environment having a series of possible touch points on an activation surface, with the monitoring of the touch points being achieved by sensing activation values at a plurality of positions around the periphery of the activation surface, the method including the step of: (a) tracking the edge profiles of activation values around the touch points over time.

When an ambiguity occurs between multiple touch points, characteristics of the edge profiles are preferably utilised to determine the expected location of touch points. The characteristics can include one or more gradients of each edge profile. The characteristics can also include the width between adjacent edges in each edge profile.

### BRIEF DESCRIPTION OF THE DRAWINGS

Preferred embodiments of the invention will now be described, by way of example only, with reference to the accompanying drawings in which:

FIG. 1 illustrates a plan view of a conventional infrared-type touch screen showing the occurrence of a double touch ambiguity;

FIGS. 2A to 2D illustrate the ‘eclipse problem’ where moving touch points cause the double touch ambiguity to recur;

FIG. 3 illustrates a plan view of another type of infrared touch screen;

FIG. 4 illustrates a plan view of yet another type of infrared touch screen;

FIG. 5 shows, for a touch screen of the type shown in FIG. 4, one method by which a touch object can be detected and its width in one axis determined;

FIGS. 6A to 6C illustrate how a device controller can respond to a double touch event in a partially eclipsed state;

FIGS. 7A and 7B illustrate how a device controller can respond to a double touch event in a totally eclipsed state;

FIG. 8 illustrates how a differential between object sizes can resolve the double touch ambiguity;

FIG. 9 shows how the contact shape of a finger touch can change with pressure;

FIGS. 10A to 10C show a double touch event where the detected touch sizes vary in time;

FIGS. 11A and 11B illustrate, for a touch screen of the type shown in FIG. 4, the effect of distance from the receive side on the sharpness of a shadow cast by a touch object;

FIGS. 12A to 12D illustrate a procedure for separating the effects of movement and distance on the sharpness of a shadow cast by a touch object;

FIG. 13 illustrates a cross-sectional view of a touch screen of the type shown in FIG. 4;

FIGS. 14A and 14B show a double touch ambiguity being resolved by the removal of one touch object;

FIGS. 15A to 15C show size versus time relationships for the combined shadow of two touch objects moving through an eclipse state;

FIG. 16 illustrates a plan view of an ‘optical’ touch screen;

FIG. 17 illustrates a plan view of an ‘optical’ touch screen showing the occurrence of a double touch ambiguity;

FIG. 18 illustrates in plan view a double touch event on an infrared touch screen; and

FIG. 19 illustrates schematically one form of design implementation of a display and device controller suitable for use with the present invention.

### DETAILED DESCRIPTION OF PREFERRED EMBODIMENTS OF THE INVENTION

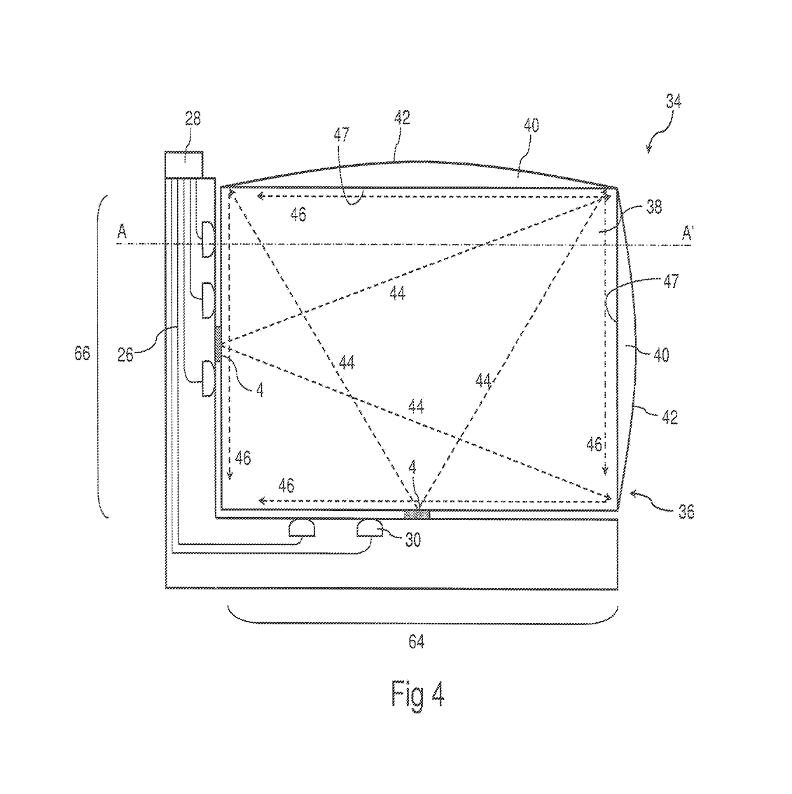

In this section we will describe various ‘software’ or ‘firmware’ methods for enhancing the multi-touch capability of infrared-style touch screens without the requirement of additional hardware components. For convenience, the double touch ambiguity and the eclipse problem will be discussed as separate aspects of multi-touch capability. By way of example only, the methods of the present invention will be described with reference to the type of infrared touch screen shown in FIG. 4, where the sensing light is in the form of two orthogonal sheets of light directed towards arrays of receive waveguides. However many of the methods are applicable to infrared touch screens in general, as well as to optical, SAW and projected capacitive touch screens, possibly with minor modifications that will occur to those skilled in the art. The methods will be described with regard to the resolution of double touch events, however it will be understood that the methods are also applicable to the resolution of touch events involving three or more contact points.

Firstly, we will briefly describe one method by which the FIG. 4 touch screen detects a touch event. FIG. 5 shows a plot of sensed activation values in the form of received optical intensity versus pixel position across a portion of the multi-element detector of a touch screen, where the pixel position is related to position across one axis of the activation surface (i.e. the input area) according to the layout of the receive waveguides around the periphery of the activation surface. If an intensity variation in the activation values, in the form of a region of decreased optical intensity 48, falls below a ‘detection threshold’ 50, it is interpreted to be a touch event. The edges 52 of the touch object responsible are then determined with respect to a ‘location threshold’ 54 that may or may not coincide with the detection threshold, and the distance 55 between the edges provides a measure of the width, size or dimension of the touch object in one axis. Another important parameter is the slope of the intensity variation in the region of decreased intensity 48. There are a number of ways in which a slope parameter could be defined, and by way of example only we will define it to be the average of the gradients (magnitude only) of the intensity curve around the ‘half maximum’ level 56. In other embodiments a slope parameter may be defined differently, and may for example involve an average of the gradients at several points within the region of decreased intensity. We have found that the FIG. 4 touch screen is well suited to edge detection algorithms, providing smoothly varying intensity curves that enable precise determination of edge locations and slope parameters.

### Hardware Display

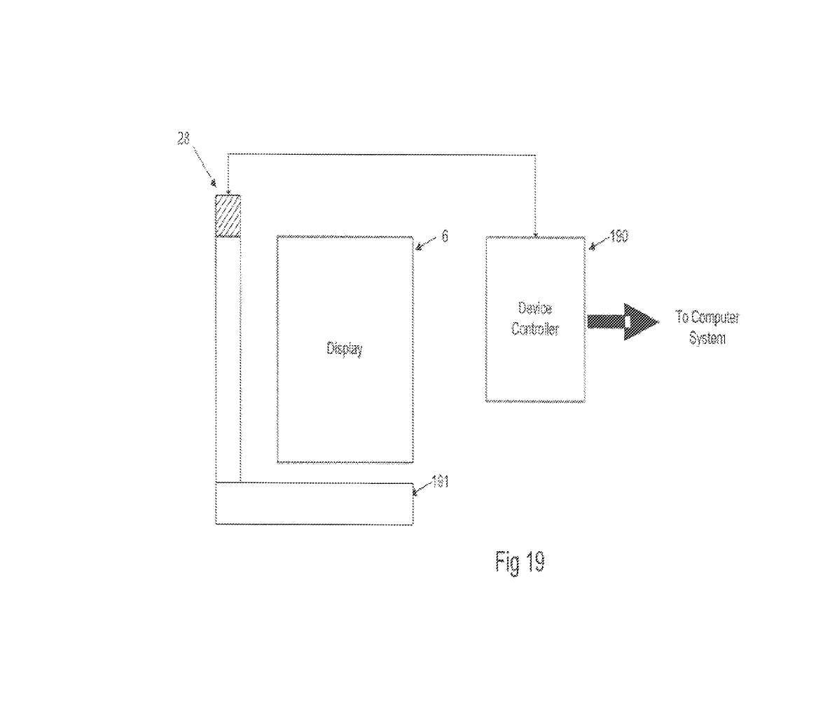

The display system can be operated in many different hardware contexts depending upon requirements. One form of hardware context is illustrated schematically in FIG. 19 wherein the periphery of a display or touch activation area 6 is surrounded by a detector array 191 interconnected via a concentrator 28 to a device controller 190. The device controller continuously monitors and stores the detector outputs at a high frame rate. The device controller can take different forms, for example a microcontroller, custom ASIC or FPGA device. The device controller implements the touch detection algorithms for output to a computer system.

For input devices that detect touch events from a reduction in detected signal intensity, an encoded algorithm in the device controller for initial touch event detection can proceed as follows:
1. Continuously monitor the intensity versus pixel position for detection of a touch event including pixel intensity below a ‘detection threshold’;
2. Where intensity below the detection threshold is determined, continuously calculate the slope gradients at one or more surrounding pixels, taking the average of the gradients as the overall gradient measure, outputting the gradient value and a distance measure across the touch event;
3. Examine the touch event positions and determine if the size and location of the touch event indicates that a partial overlap exists between two or more occluded touch events.

It will be appreciated that similar algorithms will be applicable to input devices such as projected capacitive touch screens that detect touch events from an increase in detected signal intensity.

The determination of edge locations and/or slope parameters enables several methods for enhancing the multi-touch capability of infrared touch screens. In one simple example with general applicability to many of our methods, edge detection provides up to two pieces of data to track over time for each axis of each touch shadow, rather than just tracking the centre position as is typically done in projected capacitive touch for example, thus providing a degree of redundancy that can be useful on occasion, particularly when two touch objects are in a partial eclipse state.

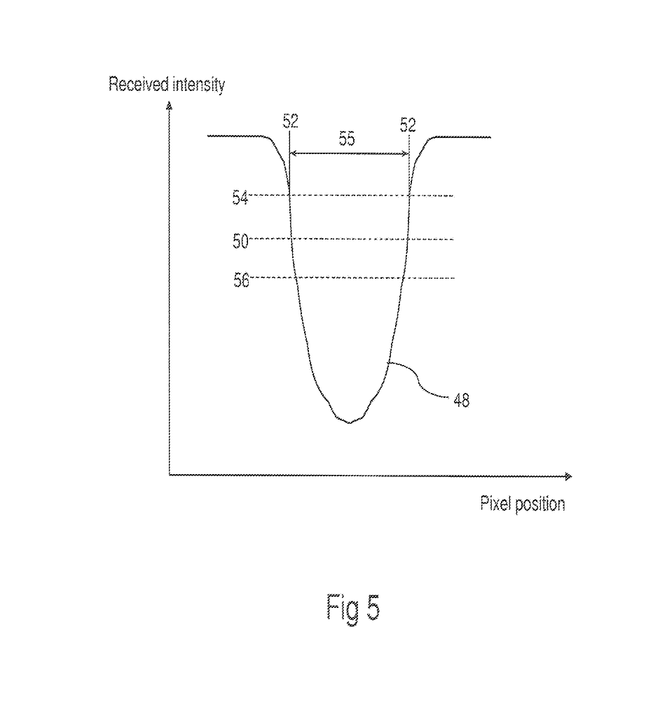

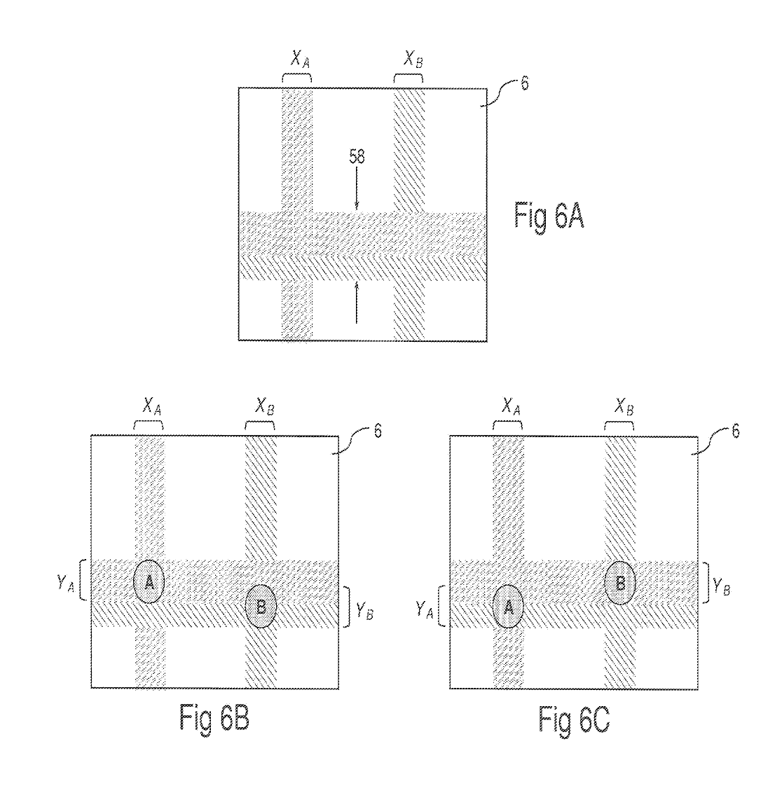

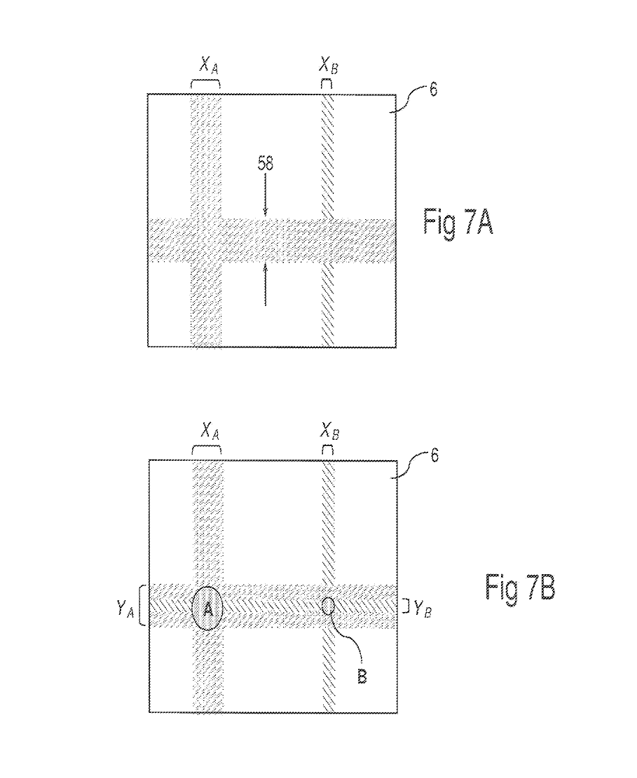

FIG. 6A shows a simulation of a double touch event on an input area 6 where the two touches are separately resolvable in the X-axis but not in the Y-axis, Detection of the edges in the X-axis edges enables the widths X_{A} and X_{B} of the two touch events to be determined, and the device controller then assumes that both touch events are symmetrical such that the widths Y_{A} and Y_{B} in the Y-axis are equal to the respective widths in the X-axis. Since the apparent Y-axis width 58 in FIG. 6A is greater than both X_{A} and X_{B}, the device controller concludes that the two touch events are in a partially eclipsed state, in one of the two possible states shown in FIGS. 6B and 6C, to be resolved by one or more of the methods described in the ‘double touch ambiguity’ section. If on the other hand the apparent Y-axis width 58 is equal to X_{A} and greater than X_{B} as shown in FIG. 7A, the controller concludes that the two touch events are in a totally eclipsed state and assumes that the touch objects are aligned in the Y-axis as shown in FIG. 7B. A similar situation prevails if the apparent Y-axis width is equal to both X_{A} and X_{B} (apparently identical touch objects).

Double Touch Ambiguity

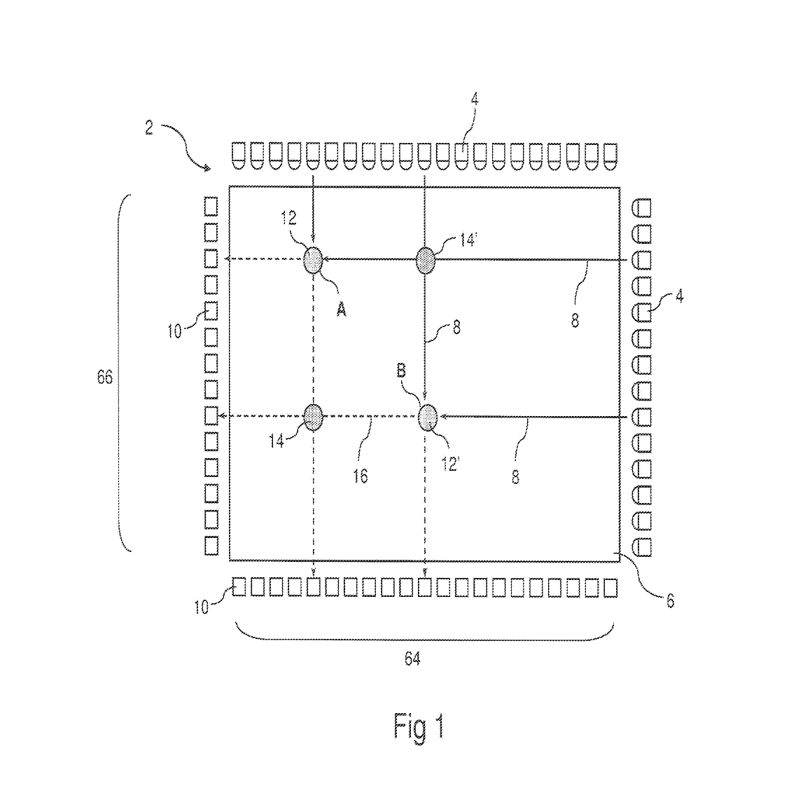

One method for dealing with double touch ambiguity, which we will refer to as the ‘differential timing’ method, is to observe the touch down timing of the two touch events. Referring to FIG. 1, if touch object A touches down and is detected before touch object B, at least within the timing resolution of the system (determined by the frame rate), then the device controller can determine that object A is at location 12, from which it follows that object B will be at location 12′ rather than at either of the phantom locations 14, 14′. The higher the frame rate, the more closely spaced in time that touch events A and B can be resolved.

In this embodiment, the device controller can be additionally programmed to detect a double touch ambiguity. This can be achieved by including time based tracking of the evolution of the structure of each touch event.

Expected touch locations can also be of value in dealing with a double touch ambiguity; for example the device controller may determine that one pair of the four candidate points arising from an ambiguous double touch event is more likely, say because they correspond to the locations of certain icons on an associated display.

The device controller can therefore download and store from an associated user interface driver, the information content of the user interface and the location of icons associated therewith. Where a double touch ambiguity is present, a weighting can be applied weighting the resolution towards current icon positions.

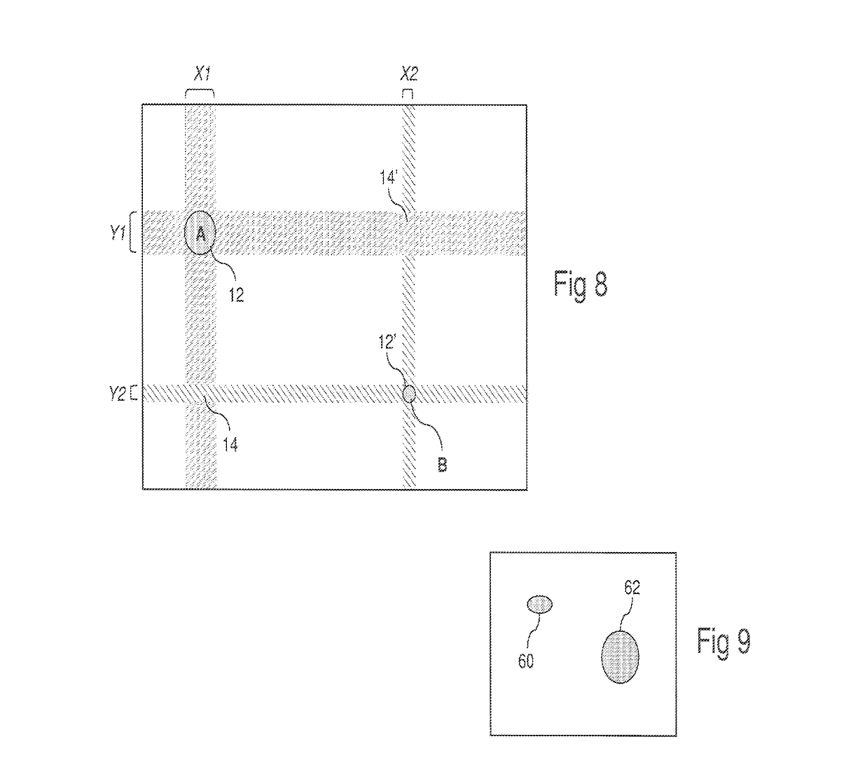

Another method, making use of object size as determined from shadow edges described above with reference to FIG. 5, can be of value if the two touch objects are of significantly different sizes. As shown in FIG. 8 for example, when faced with four possible touch locations for two differently sized touch objects A and B, it is more likely that the two larger dimensions X1 and Y1 are associated with one touch object (A) and the two smaller dimensions X2 and Y2 are associated with the other object (B), i.e. the objects are located at positions 12, 12′ rather than at positions 14, 14′.

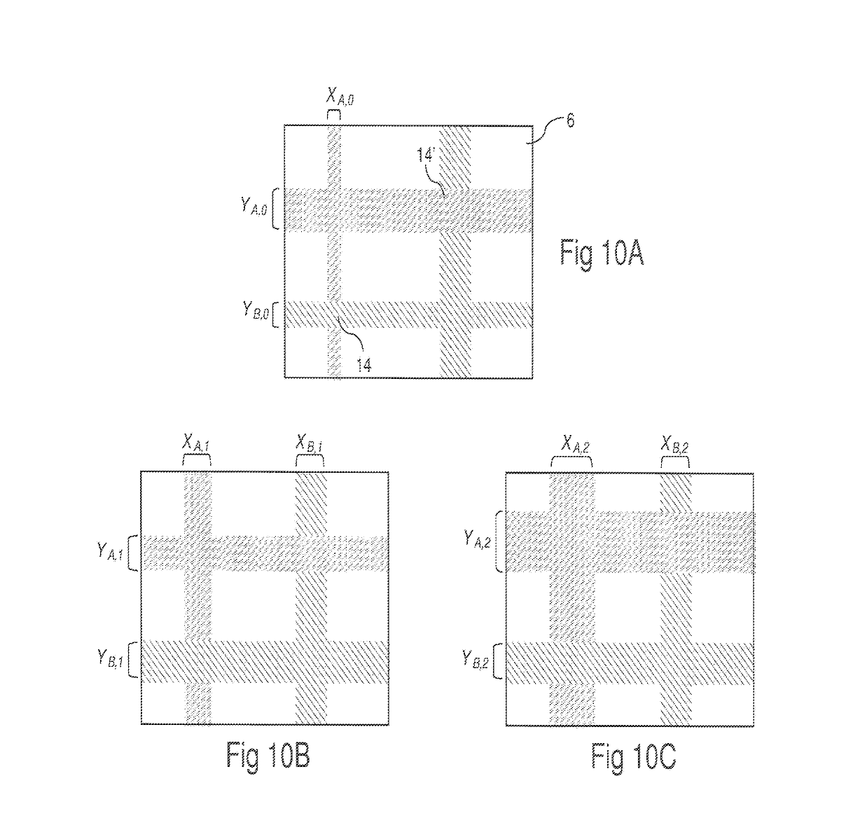

This ‘size matching’ method can be extended such that touch sizes in the X and Y-axes are measured and compared on two or more occasions rather than just once. This recognises the fact that a touch size in one or both axes may vary over time, for example if a finger touch begins with light pressure (smaller area) before the touch size increases with increasing pressure. As shown in FIG. 9, a user may initiate contact with a light fingertip touch that has a somewhat elliptical shape 60 before pressing harder and rolling onto the finger pad that will be detected as a larger, more circular shape 62. FIG. 10A shows a simulation of a double touch event on an input area 6 where the X dimension of one touch event (touch A) at an initial time t=0 (X_{A,0}) is much smaller than its Y dimension (Y_{A,0}), and closer to the Y dimension of touch B (Y_{B,0}). With this t=0 information alone, the device controller may associate X_{A,0} with Y_{B,0} and conclude erroneously that the touch objects are at the ‘phantom’ positions 14, 14′. FIGS. 10B and 10C show the detected touch sizes changing over time during the touch event, such that the two touch objects appear to be of comparable size in both axes at a later time t=1 (i.e. X_{A,1}˜Y_{A,1}˜X_{B,1}˜Y_{B,1}, FIG. 10B), and touch object A appears significantly larger than touch object B at a still later time t=2 (X_{A,2}˜Y_{A,2}>X_{B,2}˜Y_{B,2}, FIG. 10C). By measuring the touch sizes two or more times instead of just once, at intervals that need only be of the order of milliseconds or tens of milliseconds, the device controller is more likely to make the correct X, Y associations and determine the two touch locations correctly. The skilled person will recognise that there are many ways in which this procedure could be formalised mathematically. By way of example only, the correct association could be determined as being the maximum of the following two equations describing N+1 sampling events:

$$\begin{matrix}{\sum }_{t = 0}^{N} ( {X}_{A , t} * {Y}_{A , t} ) + {\sum }_{t = 0}^{N} ( {X}_{B , t} * {Y}_{B , t} ) & ( 1 ) \\ {\sum }_{t = 0}^{N} ( {X}_{A , t} * {Y}_{B , t} ) + {\sum }_{t = 0}^{N} ( {X}_{B , t} * {Y}_{A , t} ) & ( 2 )\end{matrix}$$

where equation (1) represents a correlation for one possible association {X_{A}, Y_{A}} and {X_{B}, Y_{B}}, and equation (2) represents a correlation for the other possible association {X_{A}, Y_{B}} and {X_{A}, Y_{B}}.

Size matching can be implemented by the device controller by the examination of the time evolution of the recorded touch point structure, in particular one or more distance measures of the touch points.

It will be appreciated from FIG. 1 that the locations of the touch objects A and B could be determined unambiguously if the device controller could discern which object was closer to a given ‘transmit’ or ‘receive’ side of the input area 6. For example if the device controller could tell that object A was further than object B from the long axis receive side 64 but closer to the short axis receive side 66, it would conclude that objects A and B were at locations 12 and 12′ respectively, whereas if object A was further than object B from both receive sides the device controller would conclude that objects A and B were at locations 14′ and 14 respectively. The difficulty is, of course, to determine these relative distances, and we will now describe two methods for doing this.

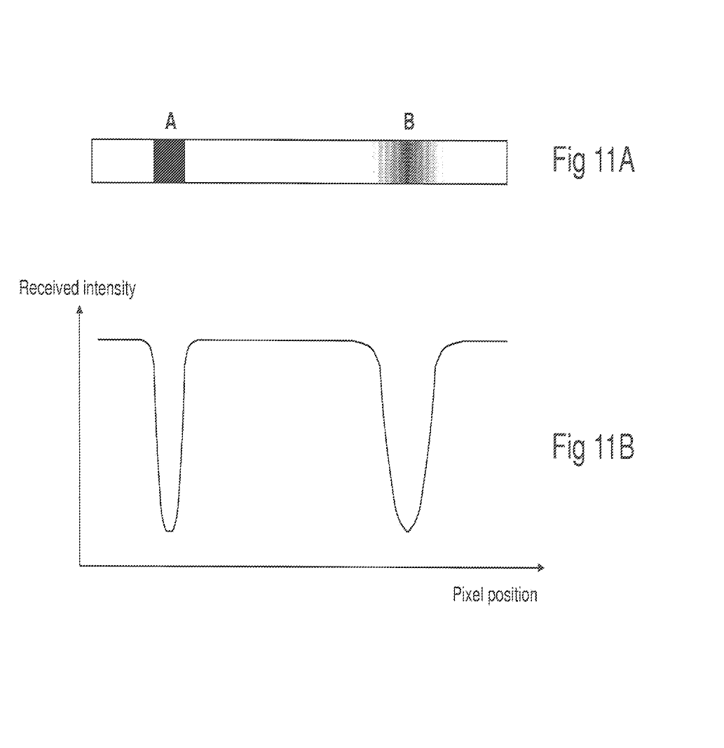

A first ‘relative distance determination’ method depends on the observation that in some circumstances the sharpness of the edges of a touch event can vary with the distance of the touch event from the relevant receive side. By way of example we will describe this shadow diffraction effect for the specific case of the infrared touch screen shown in FIG. 4, where we have observed that the edges of a touch event become more blurred the further the object is from the relevant receive waveguides 26. FIG. 11A schematically shows the shadows cast by two touch objects A and B as detected by a portion of the detector associated with one of the receive sides, while FIG. 11B shows the corresponding plot of received intensity. Object A is closer to the receive waveguides on that side and casts a crisp shadow, while object B is further from the receive waveguides and casts a blurred shadow. Mathematically, the sharpness of a shadow, or a shadow diffraction characteristic, could be expressed in similar form to a slope parameter as described above with reference to FIG. 5. The relative distances of two or more touch objects from, say, the short axis receive side could be determined from the difference(s) between their shadow diffraction characteristics, which is important because the actual characteristics may differ only slightly in magnitude; all we require is a differential. Without wishing to be bound by theory, we believe that this effect is due to the imperfect collimation of the in-plane receive waveguide lenses 30 and/or the parabolic reflectors 42, with reference to FIG. 4, perhaps caused by the fact that the light sources are not idealised point sources, and it may be possible to enhance this effect by deliberately designing the optical system to have a certain degree of imperfect collimation.

Another way of interpreting this effect is the degree to which the object is measured by the system as being in focus. In FIG. 11A, touch object A is relatively in-focus, whereas touch object B relatively out-of-focus and as such an algorithm can be used to determine the degree of focus and hence relative position. It will be appreciated by those skilled in the art that many such focussing algorithms are available and commonly used in digital still and video cameras.

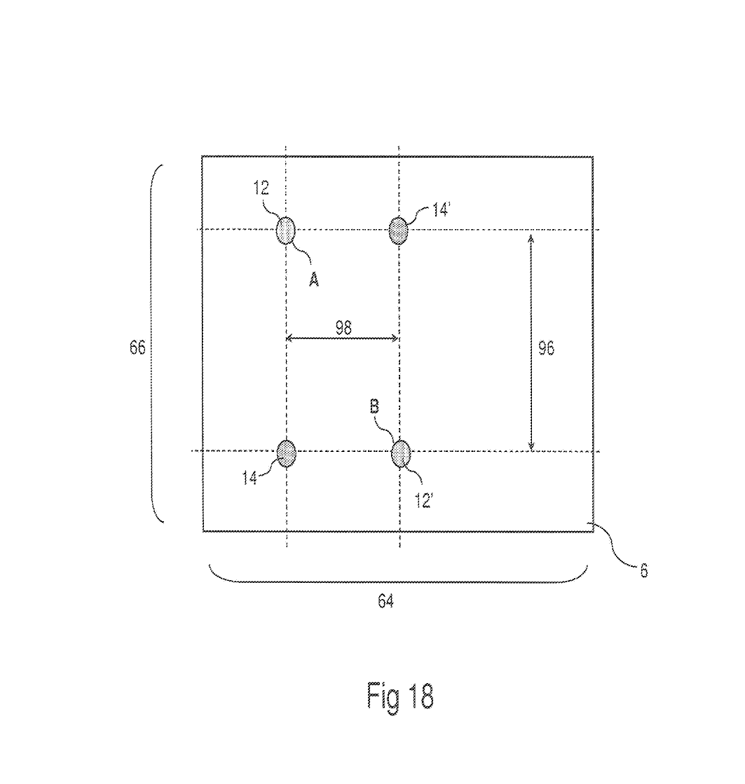

Preferably, a relative distance algorithm based on edge blurring will be applied twice, to determine the relative distances of the touch objects from both receive sides. In certain embodiments the results are weighted by the distance between the two points in the relevant axis, which can be determined from the light field in the other axis. To explain, FIG. 18 shows two touch objects A, B in an input area 6 of an infrared touch screen. Irrespective of whether the two objects are at the actual locations 12, 12′ or the phantom locations 14, 14′, the distances 96, 98 between them in each axis can be determined. In this particular case, distance 96 is greater than distance 98, so greater weight will be applied to the edge blurring observed from the long axis receive side 64.

The relative distance determination measure can be implemented on the device controller. Again the time evolution of the touch point structure can be examined to determine the gradient structure of the edges. With wider sloping sides of a current touch point, the distance from the sensor or periphery of the activation area can be determined to be greater (or lesser depending on the technology utilised). Correspondingly, narrower sloping sides indicate the opposite effect.

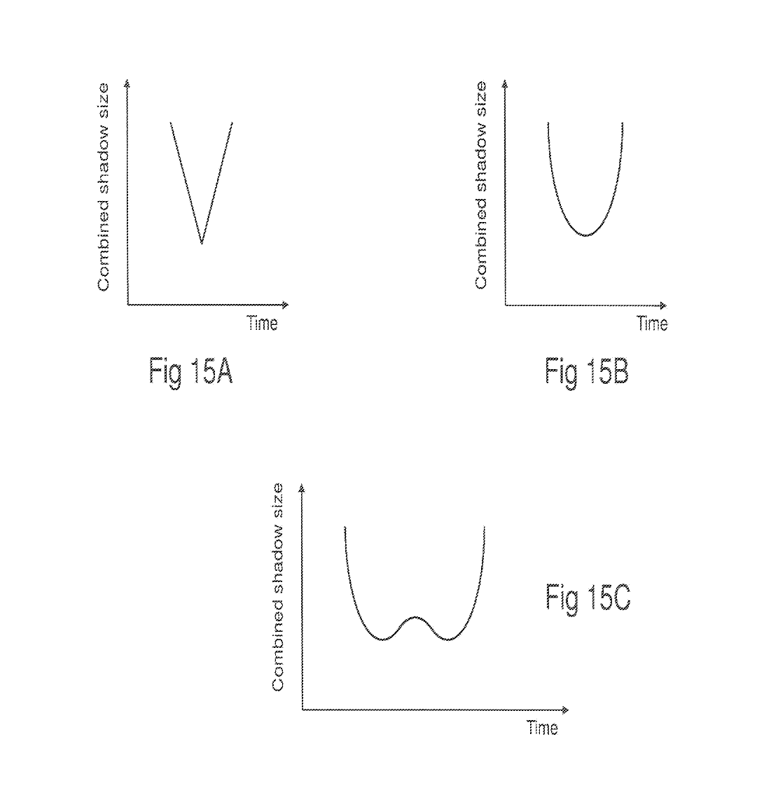

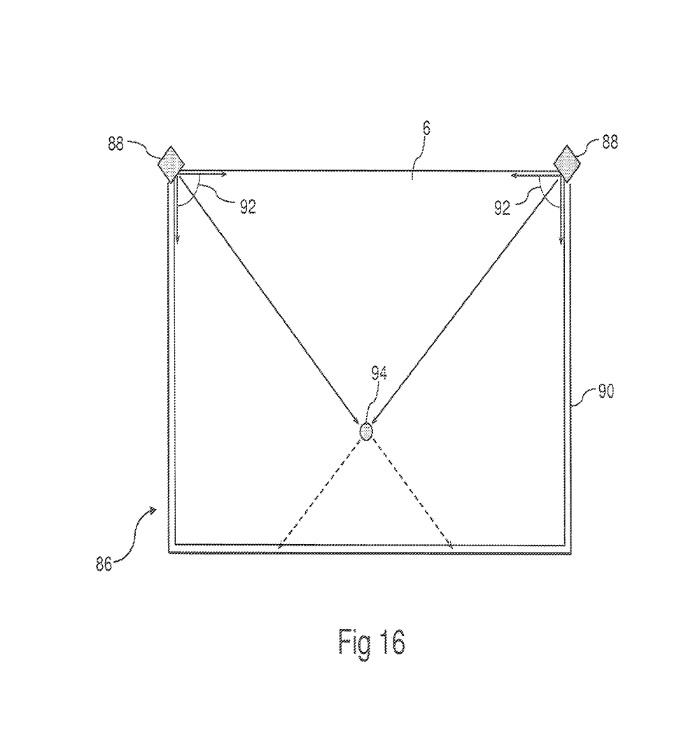

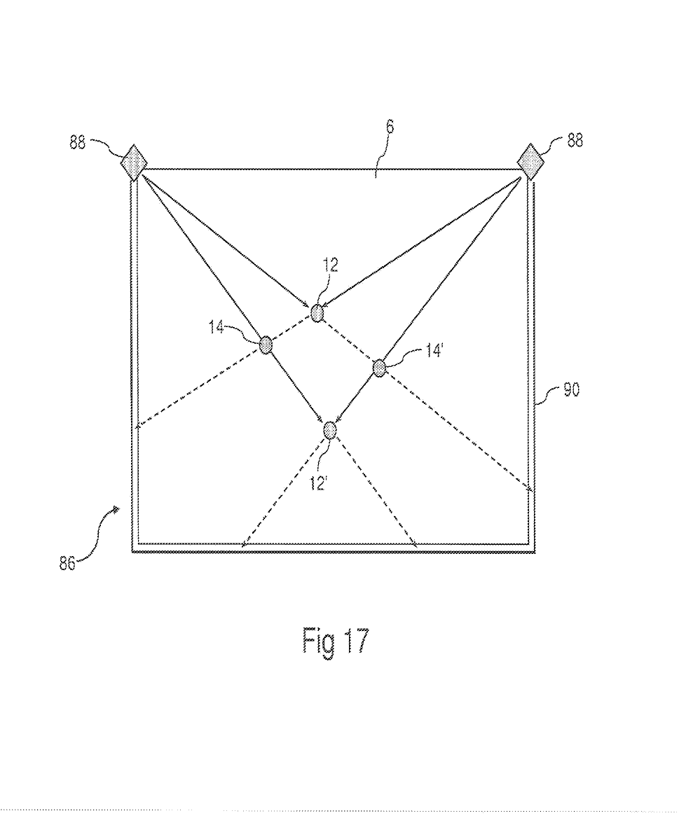

It may be that for other touch screen configurations and technologies the differential edge blurring is reversed such that objects further from the receive sides exhibit sharper edges. Nevertheless the same principles would apply, with a differential in edge sharpness being the key consideration. For example because ‘optical’ touch screens, as shown in FIGS. 16 and 17, also detect touch events via the imaging of shadows onto a line camera or similar, we expect that the sharpness of the shadows cast by an object onto the two line cameras will depend on the relative distances from the object to the line cameras. It will be appreciated from the double touch situation shown in FIG. 17 that this provides a method for distinguishing the actual touch locations 12, 12′ from the phantom points 14,14′.

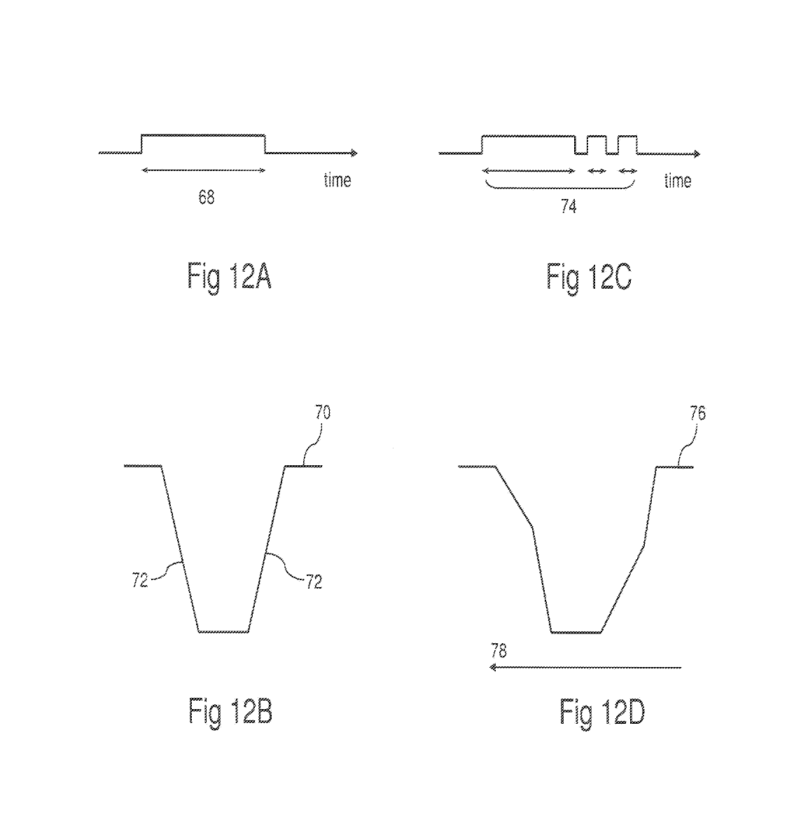

We note that our ‘edge blurring’ method could be more complicated for moving touch objects than for stationary touch objects, because edge blurring can also occur if a touch object is moving rapidly with respect to the camera shutter speed for each frame. Although we envisage that for most multi-touch input gestures a user will hold their touches stationary for a short period before moving them, probably long enough for the method to be applied, some consideration of this effect is required. One possibility is simply to use the object's movement speed (determined by tracking its edges for example) to attempt to separate the movement-induced blurring from the desired distance-induced blurring. Another possibility is to tailor the shutter behaviour of the camera used as the multi-element detector, as follows. FIG. 12A shows a standard camera shutter open period 68 for each frame, and FIG. 12B shows a portion of a received intensity plot 70 acquired during this shutter open period, similar to the plots shown in FIGS. 5 and 11B. The question is whether the sloped edges 72 of the shadow region in FIG. 12B are indicative of the distance from the receive side or caused by movement of the touch object. FIG. 12C shows an alternative camera shutter behaviour, applied to a single frame, with total open period 74 equal to the open period 68 in FIG. 12A, If an object is stationary, the shadow region of the received intensity plot will still be symmetrical as shown in FIG. 12B. If on the other hand the object is moving, the received intensity plot 76 will become asymmetrical, as shown in FIG. 12D, with arrow 78 indicating the direction of touch movement. By knowing what the shadow region of the received intensity plot should look like for a given movement speed, determined by edge tracking, it is in principle possible to deconvolute the movement and distance effects. The shutter sequence shown in FIG. 12C is basic and serves to illustrate the idea. More complex sequences, such as a pseudo random sequence, may offer superior performance in noisy conditions, or to deconvolute the movement and distance effects more accurately.

The time evolution of the edge blurring can be implemented by the device controller continuously examining the current properties or state of the edges. The shutter behaviour can be implemented by reading sensed values into a series of frame buffers at predetermined intervals and examining value evolution.

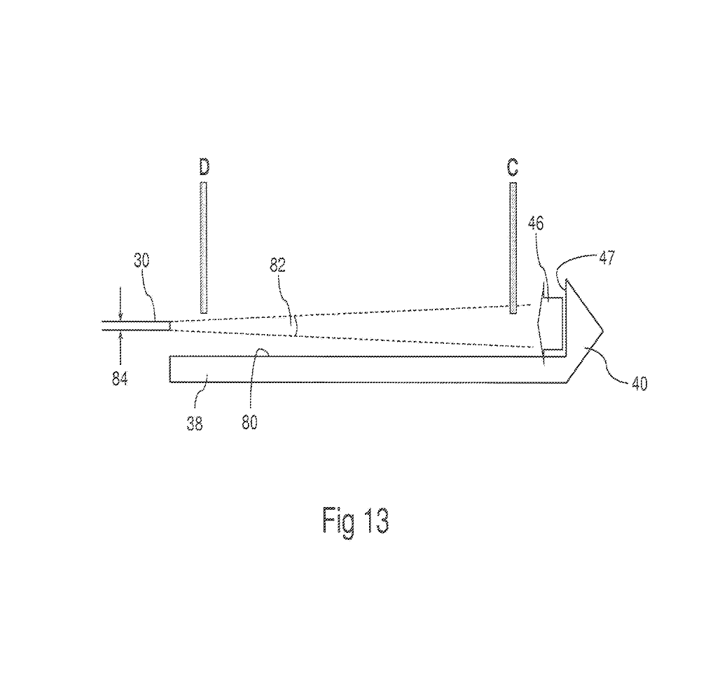

A second ‘relative distance determination’ method depends on ‘Z-axis information’, i.e. on observing the time evolution of the shadow cast by a touch object as it approaches the touch surface. FIG. 13 shows a cross-sectional view of the FIG. 4 infrared touch screen along the line A-A′, including the light guide plate 38, the upper surface of which serves as the touch surface 80, a receive side in-plane lens 30, and a collimation/redirection element 40 that emits a sheet of sensing light 46 from its exit facet 47. The in-plane lens has an acceptance angle 82 defining the range of angles within which light rays can be collected, to be guided to the detector via a receive waveguide. The in-plane lens is essentially a slab waveguide, and its acceptance angle depends, among other things, on its height 84. FIG. 13 also shows two touch objects C and D in close proximity to and equidistant from the touch surface. It can be seen that object C, further from the receive side, has intersected the acceptance angle and will therefore begin to cast a detectable shadow, whereas object D has not.

The time evolution of the touch event detection can be implemented by the device controller continuously examining the current properties of the pixel intensity variations. The shutter behaviour can be implemented by reading sensed values into a series of frame buffers at predetermined intervals and examining value evolution.

Referring to FIG. 1, and considering the long axis receive side 64, it follows that the more distant touch object A will begin to be detected before the closer touch object B, under the assumption that both objects are approaching simultaneously and at the same speed, thereby providing another piece of information for the device controller to determine the locations of A and B. For a given optical and mechanical design, including in particular the acceptance angle and the dimensions of the input area, it will be appreciated that the usefulness of this method depends on the speed of approach of the touch objects and on the frame rate of the device, since ideally there should be several ‘snapshots’ of the objects as they approach the touch surface. We estimate that for a 100 Hz frame rate, a usable differential will be observed for an approach speed of 40 mm/s or less. This is not a particularly fast approach speed, but faster frame rates would improve the performance of this method albeit at the expense of power consumption. If the device controller cannot resolve the ambiguity based on information obtained from this method, combined in all likelihood with information obtained from other methods described herein, the frame rate could be enhanced temporarily and the user prompted to repeat the multi-touch input. Useful information on touch location may also be acquired, for example using the ‘Z-axis’ or ‘differential timing’ methods, as the user lifts off their touches prior to re-applying them.

Eclipse Problem

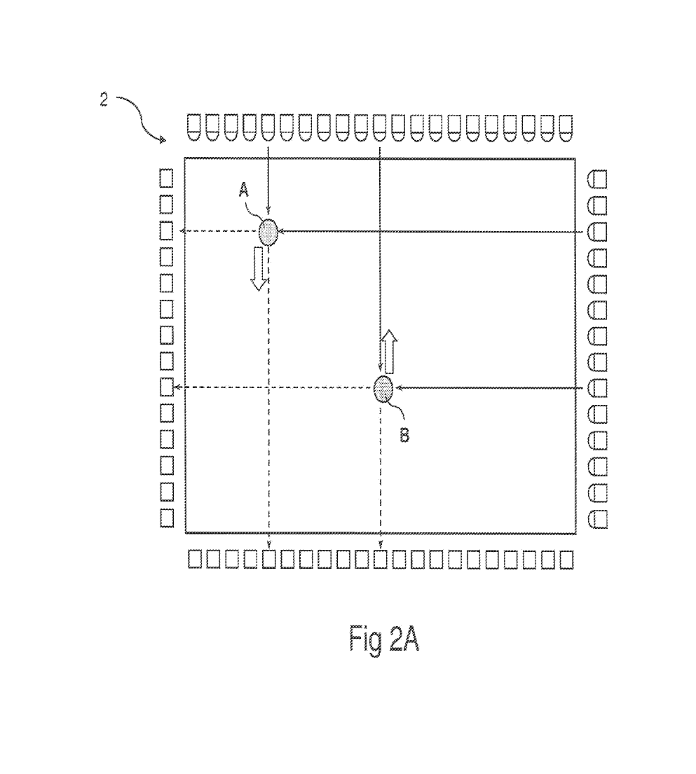

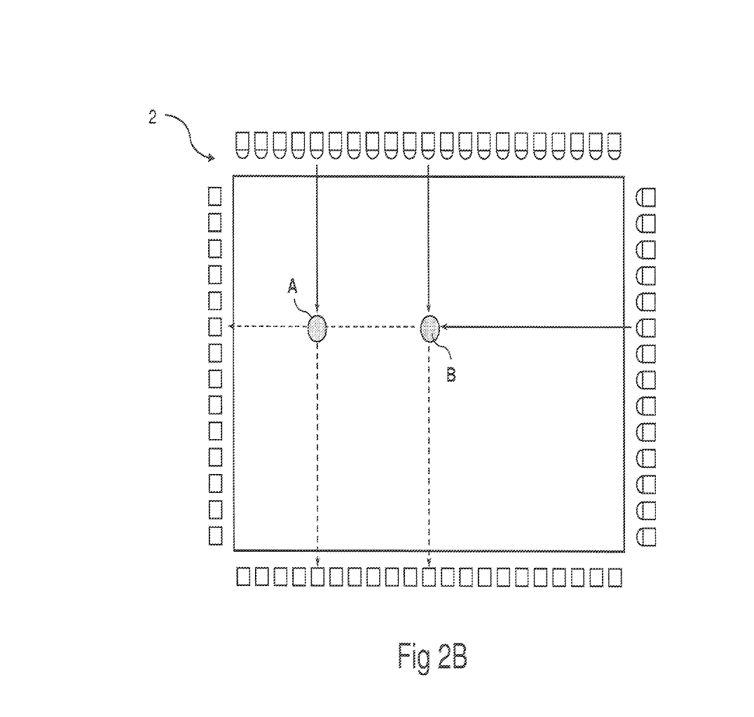

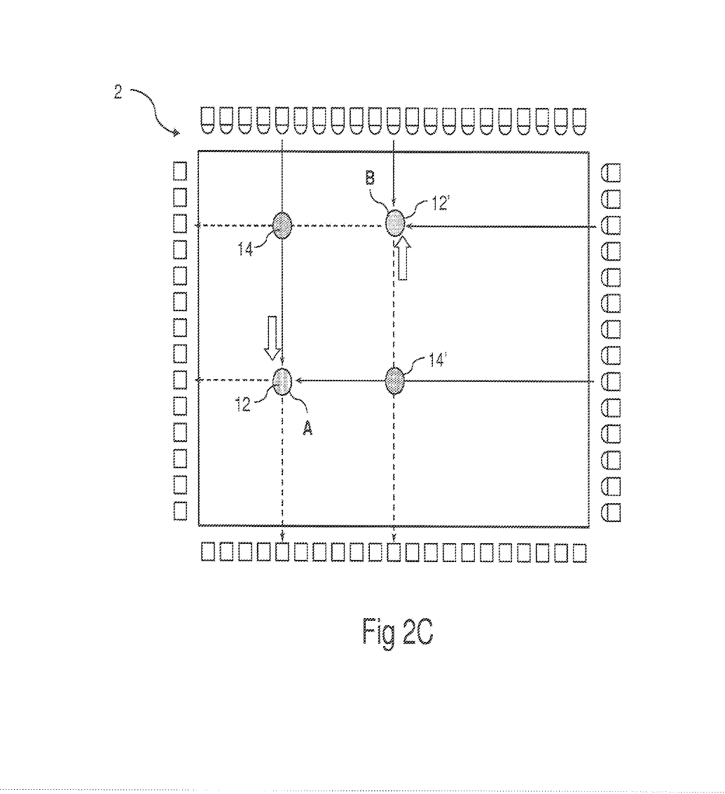

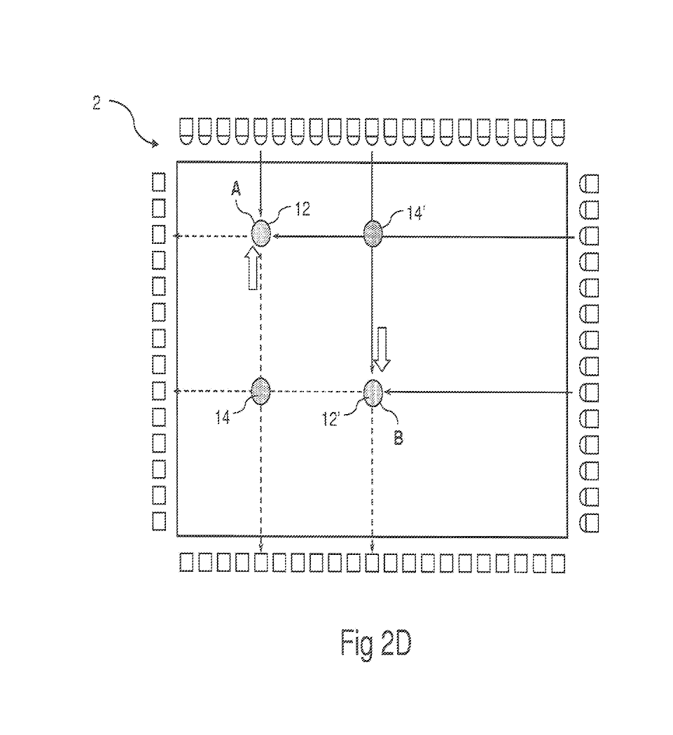

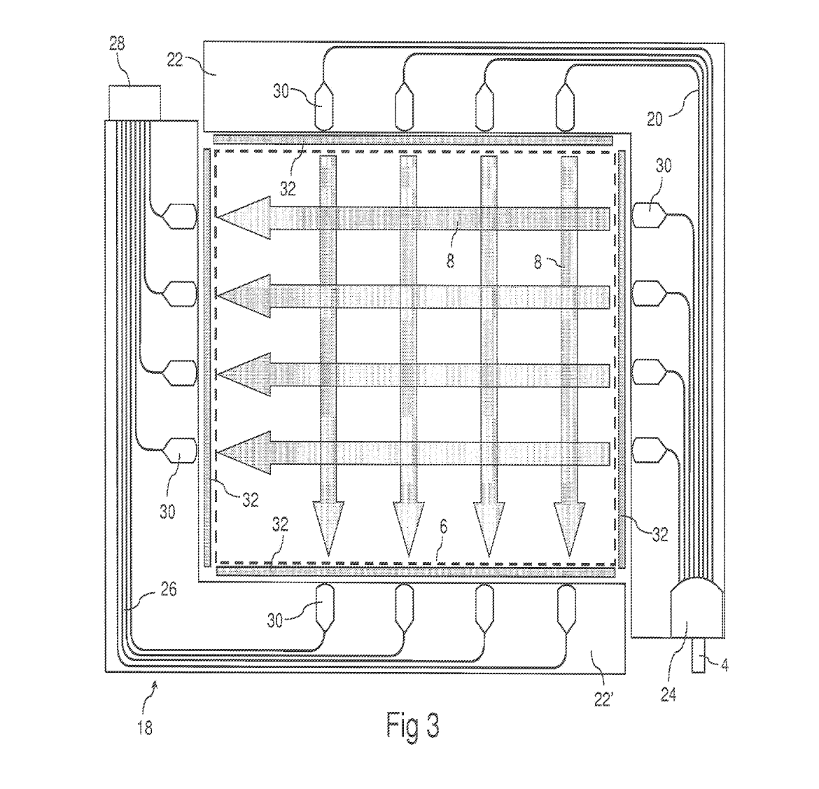

As mentioned above with reference to FIGS. 2A to 2D, further ambiguity problems can arise when two or more moving touch objects enter an eclipse state. Methods for dealing with this eclipse problem will now be described, under the general assumption that the initial positions of the touch objects have already been determined correctly using one or more of the methods described above.

One method for dealing with the eclipse problem is to apply the ‘shadow sharpness’ method described with reference to FIGS. 11A and 11B, either continuously as the objects are tracked, or after the objects emerge from an eclipse state. Either way, it will be appreciated that the ‘crossing event’ shown in FIG. 2C can be distinguished from the ‘retreating event’ shown in FIG. 2D, having regard to the possible complication of movement-induced blurring described above with reference to FIGS. 12A to 12D.

In situations where two touch objects are of different size, the eclipse problem can be addressed by re-applying the ‘size-matching’ method described above. That is, if the sizes of two moving touches are known to be significantly different before their shadows go into eclipse, this size information can be used to re-associate the shadows when they come out of eclipse.

Another method for dealing with the eclipse problem is to apply a predictive algorithm whereby the positions, velocities and/or accelerations of touch objects (or their edges) are tracked and predictions made as to where the touch objects should be when they emerge from an eclipse state. For example if two touch objects moving at approximately constant velocities (FIG. 2A) enter an eclipse state (FIG. 2B) momentarily and appear to emerge with the same velocities, it is highly likely that a ‘crossing event’ (FIG. 2C) has occurred. On the other hand if two touch objects are decelerating as they enter an eclipse state and remain eclipsed for some period of time before emerging, it is more likely that a ‘retreating event’ (FIG. 2D) has occurred. Similar considerations would apply if one object were stationary. In practice, the predictive algorithm would be applied repeatedly as objects are tracked, and the relevant terms updated after each frame. It should be noted that velocity and acceleration are vectors, so that direction of movement is also a relevant predictive factor.

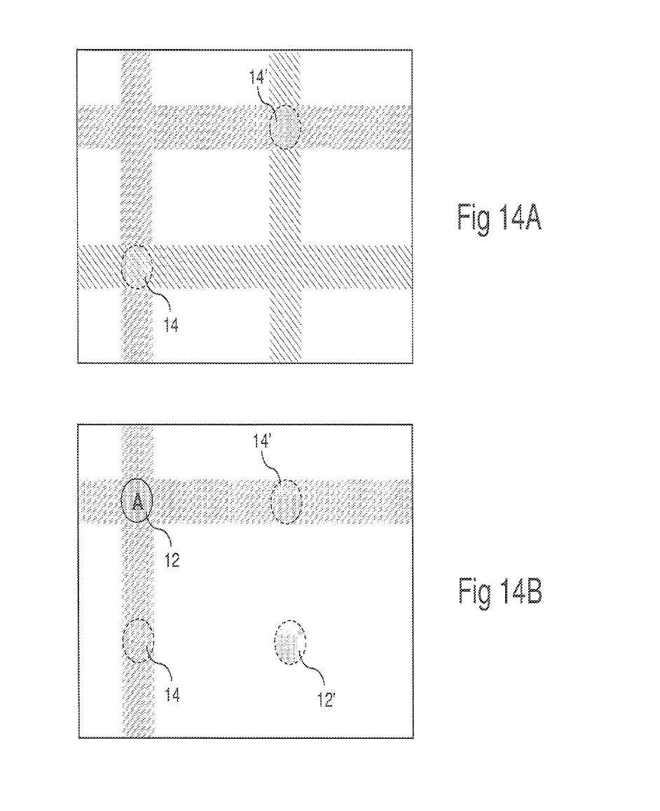

Predictive methods can also be used to correct an erroneous assignment of two or more touch locations. For example if the device controller has erroneously concluded that touch objects A and B are at the phantom locations 14, 14′ (FIG. 14A) and touch object B is removed in a time period too short for an object at either phantom location, moving or stationary as the case may be, to move suddenly to location 12 (FIG. 14B), the device controller will realise that objects A and B were actually at locations 12, 12′.

The time evolution of the touch object can be implemented by the device controller continuously examining the current touch point position or the evolutionary state of the edges. One form of implementation can include continuously reading the sensed values into a series of frame buffers and examining value evolution over time, including examining the touch point position evolution over time. This can include the shadow sharpness evolution over time.

We will now describe a variation of the previously described predictive algorithm, termed ‘temporal U/V/W shadow size analysis’, for dealing with the eclipse problem. In this analysis the size of the combined shadow that occurs in an eclipse state is monitored over time, with the size 55 determined from the edges 52 as described with reference to FIG. 5. If the size of the combined shadow grows steadily smaller, reaches a minimum momentarily then grows steadily larger, i.e. its size versus time relationship looks like a ‘V’, see FIG. 15A, then the touch objects are determined to have crossed. Alternatively if the size of the combined shadow grows smaller at a decreasing rate, reaches a minimum then grows larger at an increasing rate, i.e. its size versus time relationship looks like a ‘U’, see FIG. 15B, then the touches are determined to have stopped then retreated. Alternatively if the size of the combined shadow follows a decrease/increase/decrease/increase trajectory, i.e. its size versus time relationship looks like a rounded ‘W’, see FIG. 15C, then the touch objects are determined to have moved beyond total eclipse to a partial eclipse state before stopping and retreating.

The temporal U/V/W shadow size analysis can be implemented by the device controller continuously examining the current properties or state of the edges. The evolution over time can be examined to determine which of the behaviours are present.

It will be appreciated that the described embodiments provide methods for enhancing the multi-touch capability of touch screens, and infrared-style touch screens in particular, by improving the resolution of the double touch ambiguity and/or improving the tracking of multiple touch objects through eclipse states. The methods described herein can be used individually or in any sequence or combination to provide the desired multi-touch performance. Furthermore the methods can be used in conjunction with other known techniques.

Although the invention has been described with reference to specific examples, it will be appreciated by those skilled in the art that the invention may be embodied in many other forms.

1. In a touch sensitive user interface environment have a series of possible touch points on an activation surface, with the monitoring of the touch points being achieved by sensing activation values at a plurality of positions around the periphery of the activation surface, a method of determining where at least one touch point has been activated on the surface, the method including the steps of:
(a) determining at least one intensity variation in the activation values: and
(b) utilizing a gradient measure of the sides of the at least one intensity variation to determine the location of at least one touch point on the activation surface.

2. The method as claimed in claim 1 wherein the number of touch points is at least two and the location of the touch points is determined by reading multiple intensity variations along the periphery of the activation surface and correlating the multiple points to determine likely touch points.

3. The method as claimed in claim 1 wherein adjacent opposed gradient measures of at least one intensity variation are utilized to disambiguate multiple touch point.

4. The method as claimed in claim 1 wherein the method further includes the steps of:
continuously monitoring the time evolution of the intensity variations in the activation values; and
utilizing the time evolution in disambiguating multiple touch points.

5. The method as claimed in claim 4 wherein a first identified intensity variation is utilized in determining the location of a first touch point and a second identified intensity variation is utilized in determining the location of a second touch point.

6. The method as claimed in claim 2 wherein said activation surface includes a projected series of icons thereon and said disambiguation favours touch point locations corresponding to the icon positions.

7. The method as claimed in claim 1 wherein
the dimensions of the intensity variations are utilized in determining the location of the at least one touch point.

8. The method as claimed in claim 1 wherein:
recorded shadow diffraction characteristics of an object are utilized in disambiguating possible touch points.

9. The method as claimed in claim 8 wherein:
the sharpness of the shadow diffraction characteristics are associated with the distance of the object from the periphery of the activation area.

10. The method as claimed in claim 1 wherein disambiguation of possible touch points is achieved by monitoring the time evolution profile of the intensity variations and projecting future locations of each touch point.

11. A method of determining the location of one or more touch points on a touch sensitive user interface environment having a series of possible touch points on an activation surface, with the monitoring of the touch points being achieved by activation values at a plurality of positions around the periphery of the activation surface, said method including the step of:
(a) tracking the edge profiles of activation values around the touch points over time.

12. The method as claimed in claim 11 wherein, when an ambiguity occurs between multiple touch points, characteristics of the edge profiles are utilized to determine the expected location of touch points.

13. The method as claimed in claim 12 wherein the characteristics include one or more gradients of each edge profile.

14. The method as claimed in claim 12 wherein the characteristics include the width between adjacent edges in each edge profile.

15. (canceled)
